(19) United States
(12) Patent Application Publication
(10) Pub. No.: US 2015/0246502 A1
(43) Pub. Date: Sep. 3, 2015

(54) Impact Absorbing Composite Material

(71) Applicant: LLOYD INDUSTRIES, INC., SAN ANTONIO, FL (US)

(72) Inventor: John Lloyd, San Antonio, FL (US)

(21) Appl. No.: 14/297,765

(22) Filed: Jun. 6, 2014

(51) Int. Cl. B32B 3/14

(52) U.S. Cl. CPC B32B 3/14; B32B 2419/04; B32B 2419/06; B32B 2471/00; B32B 2571/00; B32B 2605/003; B32B 2305/026; B32B 2307/56

(57) ABSTRACT

An impact absorbing composite material includes a support layer having a top surface with a plurality of discrete impact absorbing cells arranged such that adjacent impact absorbing cells are spaced from each other. A connecting layer, comprised of an elastic material, has a bottom surface that is connected to each impact absorbing cells so as to sandwich the impact absorbing cells between the support layer and the connecting layer. A plurality of discrete tile cells are attached to the top surface of the connecting layer and arranged such that adjacent tile cells are spaced from each other and are aligned with the impact absorbing cells. The impact absorbing cells are individual respond to an impact against the material to reduce both linear and angular forces on the object striking the material. The material is particularly useful in constructing protective floor covering, protective linings, and protective surface coverings, among others.

### FIELD OF THE INVENTION

The present invention relates generally to impact absorbing materials, and more particularly, relating to an impact absorbing composite material having a plurality of cells that individually respond to an impact to reduce forces associated with linear and angular acceleration.

### BACKGROUND OF THE INVENTION

Numerous materials with a myriad of constructions have been developed to protect against injuries by absorbing impact from a sudden blow or hit. These materials have been used in floor coverings for many years to protect against injuries from falling on to a hard floor. These floor coverings are often encountered in gymnasiums, hospitals, nursing homes, recreational areas, and sports arenas. Impact absorbing materials are also used in protective gear, such as helmets, to provide protective linings for the purpose of cushioning the wearer's head against impacts. Additionally, impact absorbing materials are used as surface coverings to cover the surfaces in areas where there is a high risk of injury from falling or hitting one's head. As a non-limiting example, these surface coverings are often found in amusement rides, automobiles, and recreational areas such as playgrounds.

While the materials devised heretofore absorb forces associated with linear accelerations with varying degrees of success, they do not adequately absorb both linear and angular forces upon impact. Absorbing both linear and angular forces is critical in prevention against serious injury, including traumatic brain injury. It has been discovered that tangential forces that impart rotational acceleration on a person's head are primarily responsible for causing traumatic brain injury, including concussion, axonal trauma, brain hemorrhage, and potentially chronic traumatic encephalopathy. Accordingly, there is a need for a new impact absorbing composite material that is capable of absorbing both linear and angular forces and that is readily usable in various applications.

### SUMMARY OF THE INVENTION

In view of the foregoing disadvantages inherent in the known types of impact absorbing materials, the present invention provides a new impact absorbing composite material construction that significantly absorbs both linear and tangential forces upon impact to mitigate forces associated with linear and angular acceleration on an impact body.

It is an object of the present invention to provide an impact absorbing material that is of a simple construction and can be used in various applications to prevent injury by reducing linear and angular acceleration of a body impacting the material.

It is another object of the present invention to provide a floor covering, such as a floor mat, constructed of an impact absorbing material that prevents injury by reducing linear and angular acceleration upon impact with the floor covering.

It is another object of the present invention to provide flooring material that is constructed of an impact absorbing material that prevents injury by reducing linear and angular acceleration upon impact with the floor covering.

It is another object of the present invention to provide linings for automobile interiors that are constructed of an impact absorbing material that prevents injury by reducing linear and angular acceleration upon impact with the linings.

It is yet another object of the present invention to provide linings for protective gear that are constructed of an impact absorbing material that prevents injury by reducing linear and angular acceleration upon impact with the linings.

In general, in one aspect, an impact absorbing composite material is provided. The impact absorbing composite material includes a support layer having a top surface and a plurality of discrete impact absorbing cells disposed on the top surface of the support layer and arranged such that adjacent impact absorbing cells are spaced from each other. Each of the impact absorbing cells have a top surface that is disposed oppositely of the support layer. A connecting layer is comprised of an elastic material and has a top surface and a bottom surface. The top surface of each of the impact absorbing cells is attached to the bottom surface of the connecting layer. And, a plurality of discrete tile cells are attached to the top surface of the connecting layer and arranged such that adjacent tile cells are spaced from each other and are aligned with the impact absorbing cells.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic perspective view of an impact absorbing composite material that is constructed in accordance with the principles of an embodiment of the present invention;

FIG. 2 is a cross-sectional view of an impact absorbing composite material that is constructed in accordance with the principles of an embodiment of the present invention;

FIG. 3 is a cross-sectional view of an alternative impact absorbing composite material that is constructed in accordance with the principles of the an embodiment of the present invention;

FIG. 4 is a cross-sectional view of the impact absorbing composite material of the present invention incased within an outer, flexible covering;

FIG. 5 is a diagrammatic perspective view of a floor mat comprised of an impact absorbing composite material that is constructed in accordance with the principles of an embodiment of the present invention;

FIG. 6 is a diagrammatic cross-section of a helmet having an interior liner comprised of an impact absorbing composite material that is constructed in accordance with the principles of an embodiment of the present invention;

FIG. 7 is a diagrammatic view of an automobile interior having an interior lining comprised of an impact absorbing composite material that is constructed in accordance with the principles of an embodiment of the present invention;

FIG. 8 is a diagrammatic top view of a surface covering module comprised of an impact absorbing composite material that is constructed in accordance with the principles of an embodiment of the present invention;

FIG. 9 is a diagrammatic perspective view of a surface overlaid with a plurality of interconnected surface covering modules comprised of an impact absorbing composite material that is constructed in accordance with the principles of an embodiment of the present invention; and

FIG. 10 is a diagrammatic, partial perspective view of two surface covering modules being joined together by a connecting member, the surface covering modules being comprised of an impact absorbing composite material that is constructed in accordance with the principles of an embodiment of the present invention.

### DETAILED DESCRIPTION OF THE INVENTION

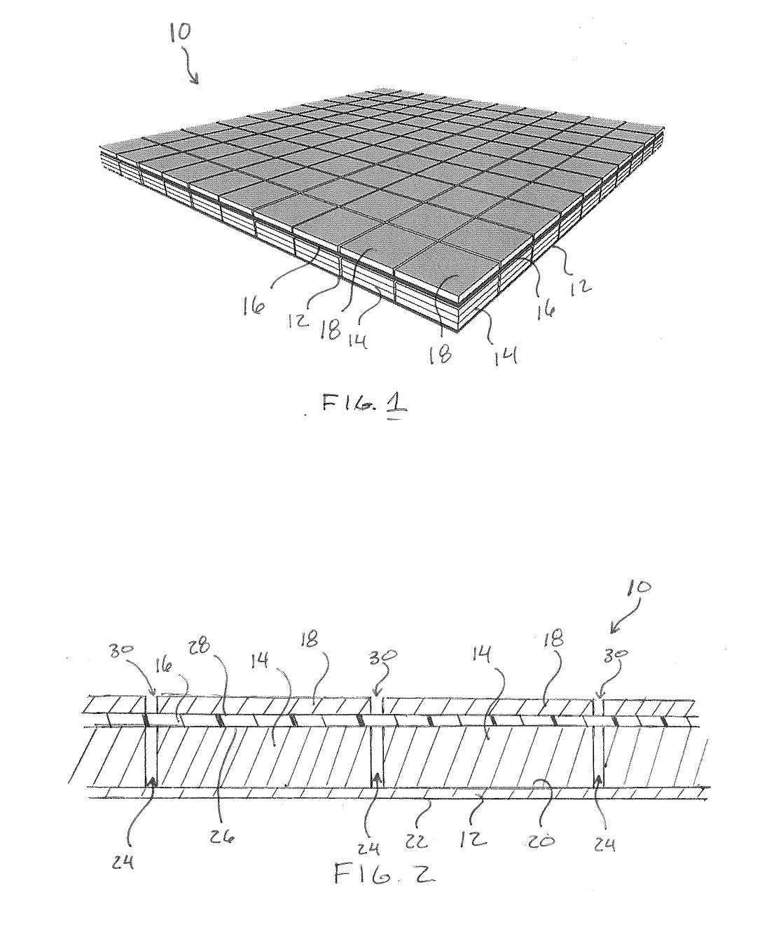

With reference to FIGS. 1 and 2, there is representatively illustrated a new impact absorbing composite material 10 in accordance with an embodiment of the present invention. The impact absorbing composite material 10 comprises a plurality of discrete cell structures that independently respond to impact from an object to reduce both linear and tangential forces on the object, which reduces the linear acceleration and angular acceleration of the object during and after impact. This reduction of linear and angular acceleration is critical in preventing traumatic brain injury to a person that experiences a sudden blow to the head, for example, during contact sports, automobile accidents, or during a fall.

The impact absorbing composite material can be used in many applications to reduce or prevent injury. As a not limiting example, embodiments of the impact absorbing composite material are particularly useful in flooring, floor mats, flooring coverings, surface coverings and protective gear or clothing, among other uses.

The impact absorbing composite material 10 includes a support layer 12, a plurality of discrete impact absorbing cells 14, an intermediate connecting layer 16, and a plurality of tile cells 18. The support layer 12 has a top surface 20 and a bottom surface 22, and may be rigid or flexible to conform to a multi-dimensional surface. The support layer may be formed of woven or nonwoven textile, cloth, fabric, vinyl, or rubber, for example. In an aspect, the support later is comprised of an inelastic material. In certain embodiments, the bottom surface 22 may be textured or constructed to have a high coefficient of friction to prevent the composite material from slipping across a surface on which it is laid. In other embodiments, the bottom surface 22 may have an adhesive coating to adhere the composite material to an attachment surface.

The plurality of impact absorbing cells 14 are disposed on the top surface 20 of the support layer 12 and are arranged such that adjacent impact absorbing cells are spaced from each other, thereby forming a gap 24 between the sidewalls of adjacent impact absorbing cells. The impact absorbing cells 14 are attached, bonded, integral, or otherwise connected to the supporting layer 12 such that each cell is conjoined with the support layer. Although, the impact absorbing cells 14 are illustrated as being evenly distributed across the support layer 12, they could be irregularly distributed across the support layer. Additionally, the impact absorbing cells 14 may all have the same shape and size or may have different shapes and sizes. In a particular aspect, the impact absorbing cells 14 are generally cubic shaped and are about 50 mm by 50 mm and are evenly spaced across the support layer with about a 2.5 mm gap between each cell and are between about 10 mm to about 15 mm thick.

The impact absorbing cells 14 can be formed of a single layer of material (FIG. 2) or can be formed of multiple layers of material (FIG. 1). In a particular aspect, the impact absorbing cells 14 are comprised of a rate dependent material, such as, for example PORON® XRD available from Rogers Corporation. Rate dependent in this context means that the deformation of the material depends on the rate at which loads are applied.

In other aspects, the impact absorbing cells 14 can be comprised of one or more of the following materials: microcellular open cell foams, microcellular closed cell foams, thermoplastic polyurethane (available, for example, from Skydex Technologies), military-grade materials, impact absorbing silicone, D30® impact absorbing material, impact gel, wovens, non-wovens, cotton, elastomers, IMPAXX® energy-absorbing foam (available from Dow Automotive), DEFLEXION shock absorbing material (available from Dow Corning), styrofoam, polymer gels, general shock absorbing elastometers, visco-elastic polymers, PORON® XRD impact protection (available from Rogers Corporation), Sorbothane® (available from Sorbothane Inc.), Neoprene (available from DuPont), Ethyl Vinyl Acetate, impact-dispersing gels, foams, rubbers, etc.

As best seen in FIG. 2, the connecting layer 16 has a bottom surface 26 and a top surface 28. The impact absorbing cells 14 are attached, bonded, integral, or otherwise connected to the bottom surface 26 of the connecting layer 16, such that they are sandwiched between the connecting layer and the supporting layer 12. The connecting layer 16 is comprised of an elastic material that deforms so as to allow relative displacement between adjacent impact absorbing cells 14. In other words, the connecting layer 16 is constructed so as to permit each impact absorbing cell 14 to independently respond to an impact on the composite material 10.

Tile cells 18 are attached, bonded, integral, or otherwise connected to the top surface 28 of the connecting layer 16 and are arranged such that adjacent tile cells are spaced from each other, thereby forming a gap 30 between the sidewalls of adjacent tile cells. Particularly, tile cells 18 are arranged to be aligned with the impact absorbing cells 14 and are sized to match the size of a corresponding impact absorbing cell 14 such that the tile cell substantially overlays the corresponding impact absorbing cell with gaps 24 and 30 substantially being equal. Collectively, tile cells 18 form the outermost layer of the composite material 10, and may be comprised of any suitable material that is desired to finish the composite material. As a non-limiting example, tile cells 18 may be plastic, metal, rubber, carpeting, vinyl, wood, wood laminate, linoleum, textile, fabric, cloth, etc. Preferably, tile cells 18 are of an antimicrobial and a fire retardant material.

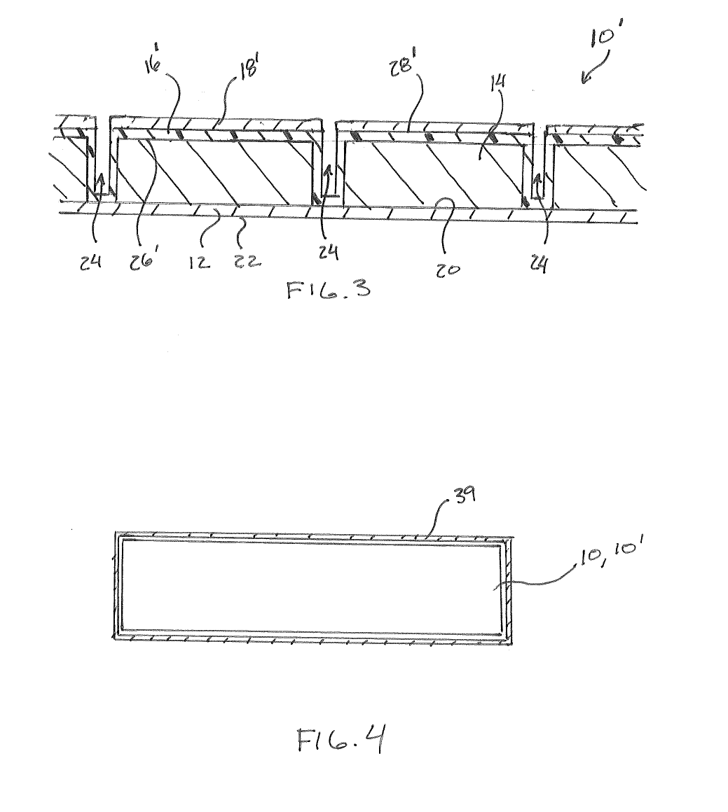

Referring to FIG. 3, as an alternative, another impact absorbing composite material 10′ is illustrated and constructed according to an embodiment of the invention. The impact absorbing composite material 10′ is similar to the impact absorbing composite material 10, with the exception that connecting layer 16 is replaced by connecting layer 16′ and tile cells are replaced by tile cells 18′. Here, connecting layer 16′ includes a bottom surface 26′ and a top surface 28′. The bottom surface 26′ is attached, connected, or otherwise bonded to the top and sidewalls of each impact absorbing cell 14 and is attached, connected, or otherwise bonded to the top surface 20 of the supporting layer 12 between each impact absorbing cell, thereby completely incasing each impact absorbing cell while maintaining gap 24 between each impact absorbing cell.

Tile cells 18′ are similarly attached, connected, or otherwise bonded to the top surface 28′ of the connecting layer 16′ and arranged such that adjacent tile cells are spaced from each other, to maintain gap 24 between the sidewalls of adjacent tile cells. Particularly, tile cells 18′ are arranged to be aligned with the impact absorbing cells 14 and are sized to match the size of a corresponding impact absorbing cell 14 and the thickness of the connecting layer 16′ extending the sidewalls of the impact absorbing cell such that the tile cell substantially overlays the corresponding impact absorbing cell.

With reference to FIG. 4, the impact absorbing material described herein may be disposed within sheathing or covering 39 that is formed of a flexible material such that the covering does not prevent impact absorbing cells 14 from independently responding to force. As an example, covering 39 may constructed of vinyl, cloth, textile material, or the like.

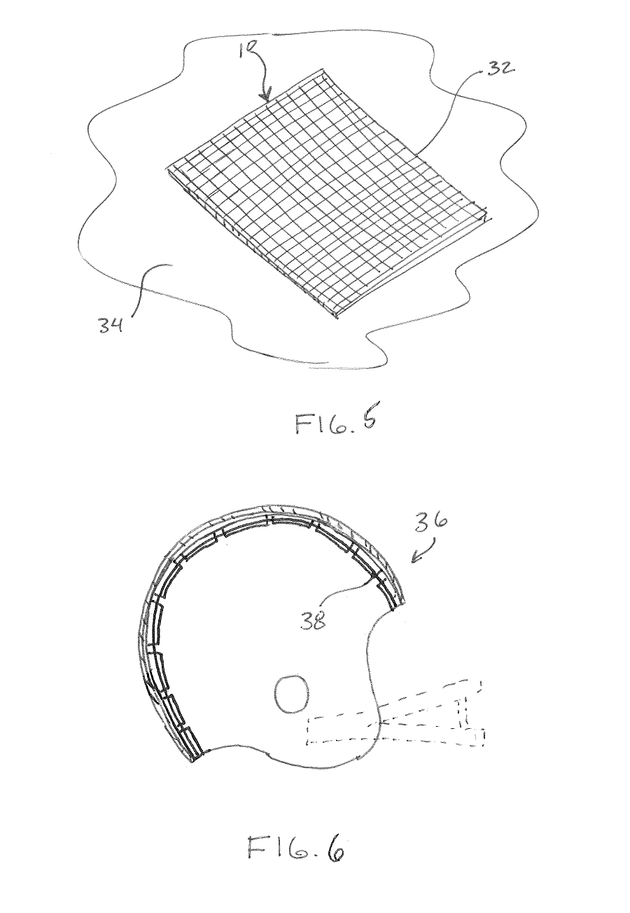

The impact absorbing material 10, 10′ is well suited for use in many applications. For example, with reference to FIG. 5, there is shown a floor mat 32 that is constructed of the impact absorbing composite material 10, 10′ in accordance with embodiments of the invention. In a care setting or hospital setting, there is a risk of injury caused from a patient falling out of bed. To prevent injury, particularly a head injury, the floor mat 32 can be positioned on the floor 34 alongside a bed (not shown) to absorb the impact from a person falling out of bed onto the underlying floor 34. The floor mat 32, construction of the impact absorbing composite material 10, 10′, has the advantage of reducing both linear and angular acceleration of the person's head when hitting the floor mat, thus preventing injury from the fall, such as traumatic brain injury, etc.

In another example, with reference to FIG. 6, there is shown a cross-section of a helmet 36 having a liner 38 that is constructed of the impact absorbing composite material 10, 10′ in accordance with embodiments of the invention. In this application, the liner 38, constructed of the impact absorbing composite material 10, 10′, reduces both the linear and angular acceleration of the wearers head upon a sudden impact to the head, for example, during a contact sport, which reduces the risk of the person receiving a traumatic brain injury.

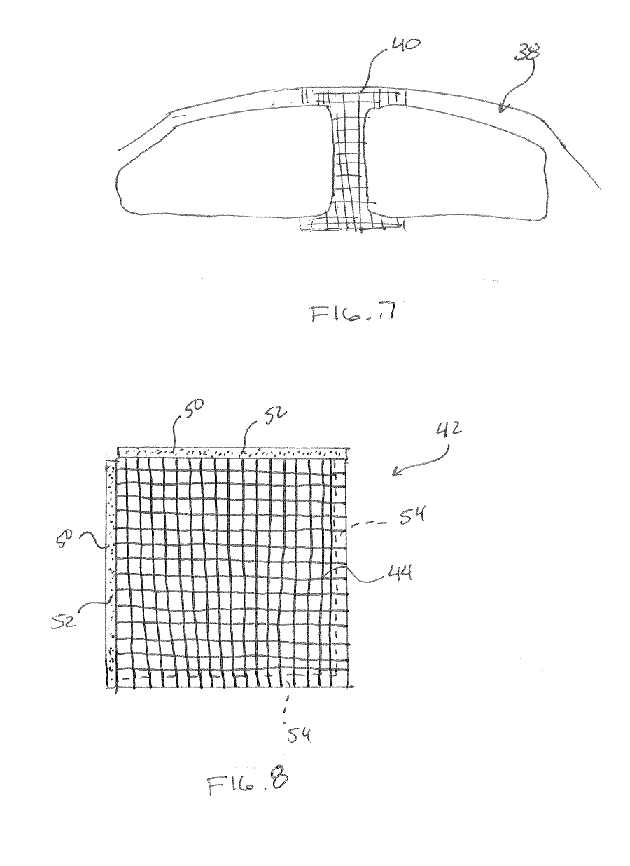

In yet another example, with reference to FIG. 7, there is diagrammatically shown the interior 38 of an automobile, and more particularly, a partial view of a B-pillar of the automobile having a cushion 40 that is constructed of the impact absorbing composite material attached to the automobile interior 38. While not shown, the cushion 40 that is constructed of the impact absorbing composite material 10, 10′ may have velour, felt, or other thin textile sheath for decorative purposes.

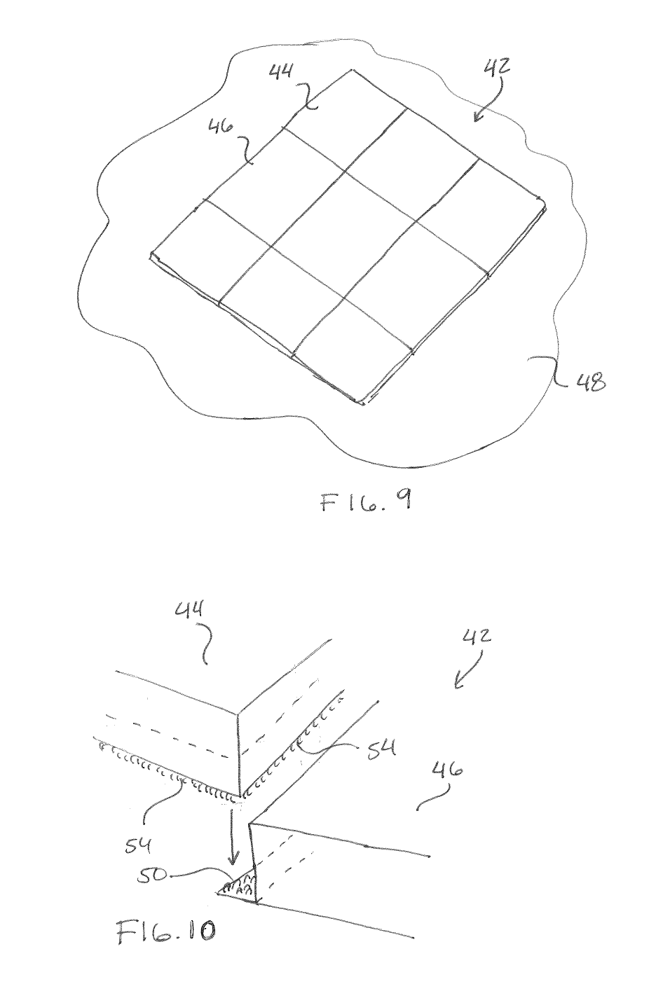

In yet another example, with reference to FIGS. 8-10, there is representatively illustrated an impact absorbing surface covering 42 that is constructed of the impact absorbing composite material 10, 10′. Particularly, the impact absorbing surface covering 42 includes a plurality (at least two) surface covering modules 44 and 46 for covering a surface, such as, for example, floor surface 48. Each surface covering module is comprised of the impact absorbing composite material 10, 10′ according to embodiments of the invention. The surface modules 44, 46 are configured to be joined together at their marginal edges when laid on the floor surface.

In an aspect, each surface covering module includes one or more connecting members 50 along its perimeter that engages with the perimeter of an adjacent surface covering module. For example, in a particular aspect, connecting member 50 is a flap that extends from the perimeter of the surface covering module. The flap 50 includes a strip of touch fastener material 52 that cooperatively connects with strip of touch fastener material 54 that is located on the bottom surface 22 of an adjacent surface covering module. To this end, any number of surface covering modules can be interconnected to cover a surface.

A number of embodiments of the present invention have been described. Nevertheless, it will be understood that various modifications may be made without departing from the spirit and scope of the invention. Accordingly, other embodiments are within the scope of the following claims.

What is claimed is:

1. An impact absorbing composite material comprising:
a support layer having a top surface;
a plurality of discrete impact absorbing cells disposed on said top surface of said support layer and arranged such that adjacent impact absorbing cells are spaced from each other, each of said impact absorbing cells having a top surface disposed oppositely of said support layer;
a connecting layer comprised of an elastic material, said connecting layer having a top surface and a bottom surface, said top surface of each of said impact absorbing cells attached to said bottom surface of said connecting layer; and
a plurality of discrete tile cells attached to said top surface of said connecting layer and arranged such that adjacent tile cells are spaced from each other and are aligned with said impact absorbing cells.

2. The impact absorbing composite material of claim 1, wherein said impact absorbing cells are comprised of one or more of microcellular open cell foams, microcellular closed cell foams, visco-elastic polymers, rate dependent materials, and elastomers.

3. The impact absorbing composite material of claim 1, wherein said support layer has a textured bottom surface.

4. The impact absorbing composite material of claim 1, wherein said composite is flooring.

5. The impact absorbing composite material of claim 1, wherein said composite is a liner of a helmet.

6. The impact absorbing composite material of claim 1, wherein said composite is a liner of an interior of a vehicle.

7. The impact absorbing composite material of claim 1, wherein at least one of said tile cells is selected from rubber, carpeting, vinyl, wood, wood laminate, and linoleum.

8. The impact absorbing composite material of claim 1, wherein said tile cells have an antimicrobial coating.

9. An impact absorbing surface covering comprising:
at least first and second surface covering modules, wherein said first and second surface covering modules can be laid on a surface so as to adjoin each other;
each surface covering module comprising:
a support layer having a top surface;
a plurality of discrete impact absorbing cells disposed on said top surface of said support layer and arranged such that adjacent impact absorbing cells are spaced from each other, each of said impact absorbing cells having a top surface disposed oppositely of said support layer;
a connecting layer comprised of an elastic material, said connecting layer having a top surface and a bottom surface, said top surface of each of said impact absorbing cells attached to said bottom surface of said connecting layer; and
a plurality of discrete tile cells attached to said top surface of said connecting layer and arranged such that adjacent tile cells are spaced from each other and are aligned with said impact absorbing cells.

10. The impact absorbing surface covering of claim 9, wherein each surface covering module further comprising:
at least one connecting member on a perimeter of the surface covering module.

11. The impact absorbing surface covering of claim 10, wherein said at least one connecting member includes a touch fastener.

12. The impact absorbing surface covering of claim 9, wherein said impact absorbing cells are comprised of one or more of microcellular open cell foams, microcellular closed cell foams, visco-elastic polymers, rate dependent materials, and elastomers.

13. The impact absorbing surface covering of claim 9, wherein at least one of said tile cells is selected from rubber, carpeting, vinyl, wood, wood laminate, and linoleum.

14. The impact absorbing surface covering of claim 9, wherein said tile cells have an antimicrobial coating.

15. An impact absorbing composite material comprising:
a support layer having a top surface, said support layer being constructed of a first material;
a plurality of discrete impact absorbing cells disposed on said top surface of said support layer and arranged such that adjacent impact absorbing cells are spaced from each other, each of said impact absorbing cells having a top surface disposed oppositely of said support layer;
a connecting layer comprised of second material that is an elastic material, said connecting layer having a top surface and a bottom surface, said top surface of each of said impact absorbing cells attached to said bottom surface of said connecting layer;
wherein said first material and said second material are dissimilar.

16. The impact absorbing composite material of claim 15, further comprising:
a plurality of discrete tile cells attached to said top surface of said connecting layer and arranged such that adjacent tile cells are spaced from each other and are aligned with said impact absorbing cells.

17. The impact absorbing composite material of claim 15, wherein said impact absorbing cells are comprised of one or more of microcellular open cell foams, microcellular closed cell foams, visco-elastic polymers, rate dependent materials, and elastomers.

18. The impact absorbing composite material of claim 15, wherein each impact absorbing cell as sidewalls that are connected to said bottom surface of said connecting layer, and wherein said bottom surface of said connecting layer is connected to said top surface of said support layer between each impact absorbing cell.

19. The impact absorbing composite material of claim 18, further comprising:
a plurality of discrete tile cells attached to said top surface of said connecting layer and arranged such that adjacent tile cells are spaced from each other and are aligned with said impact absorbing cells.

20. The impact absorbing composite material of claim 18, wherein said impact absorbing cells are comprised of one or more of microcellular open cell foams, microcellular closed cell foams, visco-elastic polymers, rate dependent materials, and elastomers.
